(19) United States
(12) Patent Application Publication
(10) Pub. No.: US 2026/0331457 A1
(43) Pub. Date: Oct. 22, 2026

(54) ALL-SOLID-STATE BATTERY

(71) Applicant: HONDA MOTOR CO., LTD., Tokyo (JP)

(72) Inventors: Tatsuya HASHIMOTO, Saitama (JP); Hiroshi AKUTSU, Saitama (JP); Atsuhiro NISHIDA, Saitama (JP); Kazufusa MIYAJIMA, Saitama (JP); Yuichi TAJIRI, Saitama (JP); Hotaka HIRATA, Saitama (JP)

(21) Appl. No.: 19/529,117

(22) Filed: Feb. 4, 2026

(30) Foreign Application Priority Data
Feb. 25, 2025 (JP) 2025-028314

(51) Int. Cl. H01M 4/13; H01M 4/02; H01M 10/0585

(52) U.S. Cl. CPC H01M 4/13; H01M 10/0585; H01M 2004/027

(57) ABSTRACT

A negative electrode layer 10, a positive electrode layer 20, and a solid electrolyte layer 30 are laminated in a T direction. One direction from among directions orthogonal to the T direction is an X direction. A direction orthogonal to the T direction and the X direction is a Y direction. A negative-electrode current collector layer 11 has a negative-electrode current collector layer body part 12, and a negative electrode tab 14 extending from the negative-electrode current collector layer body part 12 in an X-direction. The outer peripheral surface of the negative electrode layer 10 has pairs of side surface sections 13, 16 opposite from each other in the Y direction. When viewed in the T direction, each of the side surface sections 13, 16 has an uneven section 13a, 16a that includes recesses and protrusions repetitively arranged in the X direction.

### BACKGROUND OF THE INVENTION

This application is based on and claims the benefit of priority from Japanese Patent Application No. 2025-028314, filed on 25 Feb. 2025, the content of which is incorporated herein by reference.

### FIELD OF THE INVENTION

The present invention relates to an all-solid-state battery.

### RELATED ART

In recent years, research and development that pertain to secondary batteries, which contribute to the enhancement of energy efficiency, have been carried out in order to ensure that more people have access to reliable, sustainable, and advanced energy at reasonable cost.

Among secondary batteries, all-solid-state batteries, which use a solid electrolyte as the electrolyte, are excellent in terms of achieving a high safety level resulting from the incombustibility of the solid electrolyte and having a higher energy density, thereby attracting significant attention. Consideration has been given to an all-solid-state battery that has a laminate structure in which a plurality of positive electrode layers and negative electrode layers are laminated atop one another in an alternating pattern with solid electrolyte layers therebetween (e.g., Japanese Unexamined Patent Application, Publication No. 2024-90260).

In Japanese Unexamined Patent Application, Publication No. 2024-90260, the negative electrode layer is formed by laminating a current collector layer and active material layers.
Patent Document 1: Japanese Unexamined Patent Application, Publication No. 2024-90260

### SUMMARY OF THE INVENTION

When charging an all-solid-state battery, a metal (e.g., lithium) is deposited on, or caught by, the active material layer of a negative electrode layer. When discharging the all-solid-state battery, the metal deposited on, or caught by, the active material layer of the negative electrode layer is released and moves to the positive electrode layer side. Thus, the active material layer expands or contracts in association with the charging/discharging of the all-solid-state battery. The metal deposited on the active material layer of a negative electrode layer end portion or on an end portion of the negative electrode layer may possibly detach in association with the expansion or contraction of the active material layer. Hence, the negative electrode layer may possibly deteriorate while the charging/discharging of the all-solid-state battery is repeated.

The present invention addresses the problem of providing an all-solid-state battery that is unlikely to exhibit a decrease in the capacity associated with deterioration of a negative electrode layer even when charging/discharging is repeatedly performed, thereby achieving excellent cycle characteristics.
(1) A first aspect of the present invention is directed to an all-solid-state battery including: a positive electrode layer and a negative electrode layer laminated together with a solid electrolyte layer interposed therebetween, the negative electrode layer having at least a negative-electrode current collector layer, in which, a direction of lamination is defined as a laminating direction, one direction from among directions orthogonal to the laminating direction is defined as a first direction, and a direction orthogonal to the laminating direction and the first direction is defined as a second direction, the negative-electrode current collector layer has a negative electrode tab extending to one side in the first direction, the outer peripheral surface of the negative electrode layer has a pair of side surface sections opposite from each other in the second direction, and the side surface sections each have an uneven section when viewed in the laminating direction.

The all-solid-state battery according to aspect (1) can have an increased surface area for the side surface sections of the negative electrode layer so that a metal deposited on the negative electrode layer can be easily fixed to the side surface sections. In this way, it is possible to suppress the metal deposited on the negative electrode layer from detaching from the negative electrode layer, thereby suppressing deterioration of the negative electrode layer. Hence, an all-solid-state battery can be provided that is unlikely to exhibit a decrease in the capacity associated with deterioration of the negative electrode layer even when charging/discharging is repeatedly performed, thereby achieving excellent cycle characteristics.
(2) According to a second aspect, in the all-solid-state battery according to aspect (1), with respect to protrusions and recesses forming the uneven section, a distance in the second direction between the bottom of one recess and the top of a protrusion adjacent to the one recess is defined as an unevenness amount, and the unevenness amount may be 0.10 mm to 0.40 mm.

The all-solid-state battery according to aspect (2) can suppress the metal deposited on the negative-electrode active material layer from detaching from the negative-electrode active material layer, and suppress an occurrence of shorting that could be caused by a protrusion contacting the surroundings.
(3) According to a third aspect, in the all-solid-state battery according to aspect (1), with respect to protrusions and recesses forming the uneven section, a distance in the second direction between the bottom of one recess and the top of a protrusion adjacent to the one recess is defined as an unevenness amount, and the unevenness amount may be 0.40 mm or less.

The all-solid-state battery according to aspect (3) can suppress an occurrence of shorting that could be caused by a protrusion contacting the surroundings.
(4) According to a fourth aspect, in the all-solid-state battery according to aspect (1), with respect to protrusions and recesses forming the uneven section, a distance in the second direction between the bottom of one recess and the top of a protrusion adjacent to the recess is defined as an unevenness amount, and the unevenness amount may be 0.10 mm or greater.

The all-solid-state battery according to aspect (4) can suppress the metal deposited on the negative-electrode active material layer from detaching from the negative-electrode active material layer.
(5) According to a fifth aspect, in the all-solid-state battery according to aspect (1), with respect to protrusions forming the uneven section, a distance in the first direction between the top of one protrusion and the top of a protrusion adjacent to the one protrusion is defined as an unevenness pitch, and the unevenness pitch may be 0.50 mm to 1.20 mm.

If the unevenness pitch is excessively small, it would be difficult to ensure, between adjacent protrusions, spaces in which metal is to be deposited, so it may be impossible to sufficiently increase the area of portions of the uneven section on which metal can be deposited. Meanwhile, increasing the unevenness pitch makes the inclined surfaces of the uneven section smoother, thereby causing the uneven section to have a shape close to a straight line. In this case, the surface area of the uneven section may possibly not be sufficiently increased. In contrast, in the configuration of the all-solid-state battery according to aspect (5), such defects can be suppressed, thereby suppressing the metal deposited on the negative-electrode active material layer from detaching from the negative-electrode active material layer.
(6) According to a sixth aspect, in the all-solid-state battery according to aspect (1), with respect to protrusions forming the uneven section, a distance in the first direction between the top of one protrusion and the top of a protrusion adjacent to the one protrusion is defined as an unevenness pitch, and the unevenness pitch may be 0.50 mm or greater.

In the all-solid-state battery according to aspect (6), spaces in which metal is to be deposited can be ensured between adjacent protrusions, thereby sufficiently increasing the area of portions of the uneven section on which metal can be deposited.
(7) According to a seventh aspect, in the all-solid-state battery according to aspect (1), with respect to protrusions forming the uneven section, a distance in the first direction between the top of one protrusion and the top of a protrusion adjacent to the one protrusion is defined as an unevenness pitch, and the unevenness pitch may be 1.20 mm or less.

In the all-solid-state battery according to aspect (7), it is possible to suppress the uneven section assuming a shape close to a straight line, thereby sufficiently increasing the surface area of the uneven section.

The present invention can provide an all-solid-state battery that is unlikely to exhibit a decrease in the capacity associated with deterioration of a negative electrode layer even when charging/discharging is repeatedly performed, thereby achieving excellent cycle characteristics.

### BRIEF DESCRIPTION OF THE DRAWINGS

FIG. 1 is a perspective appearance view of an all-solid-state battery according to an embodiment;

FIG. 2 is a cross-sectional view of the all-solid-state battery taken on line II-II of FIG. 1;

FIG. 3 is a cross-sectional view of the all-solid-state battery taken on line III-III of FIG. 1;

FIG. 4 is an exploded perspective view of the all-solid-state battery;

FIG. 5 is a plan view of a negative-electrode active material layer as viewed in the laminating direction;

FIG. 6 is a plan view of a negative electrode layer as viewed in the laminating direction; and

FIG. 7 is an enlarged view of a VII portion of FIG. 5.

### DETAILED DESCRIPTION OF THE INVENTION

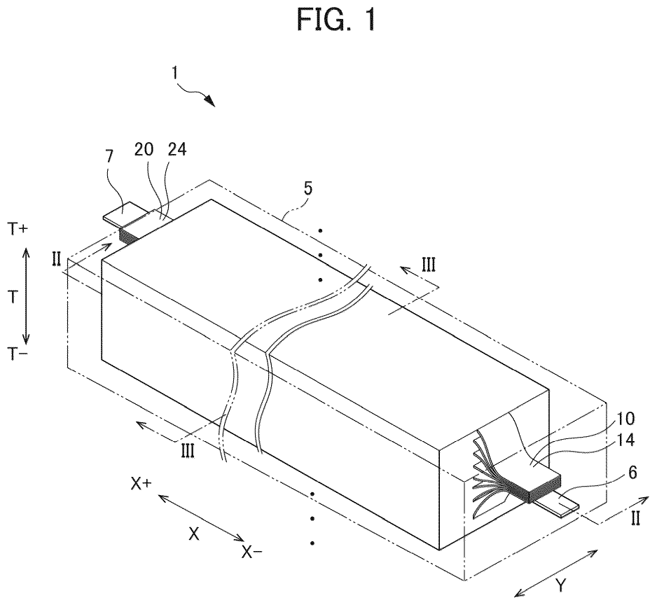

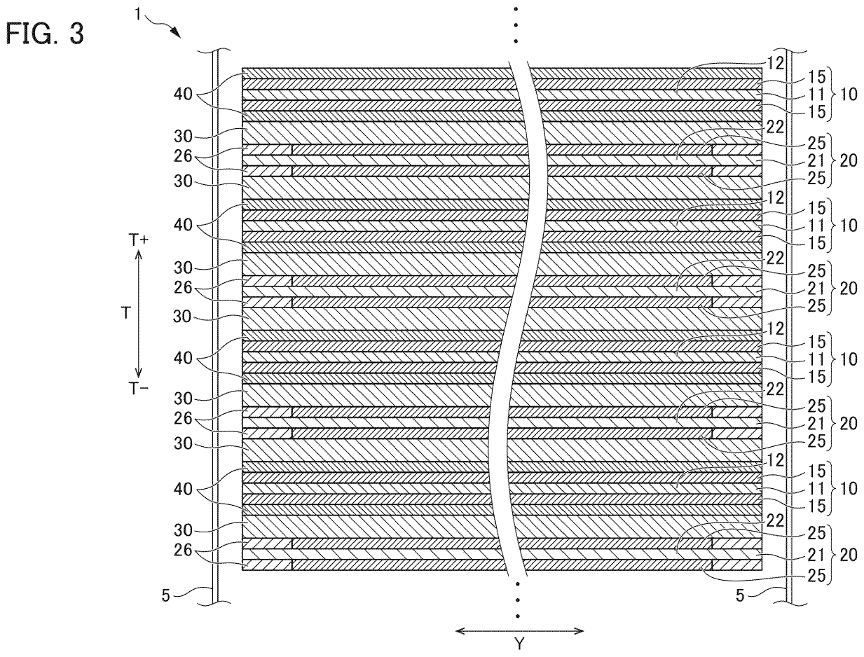

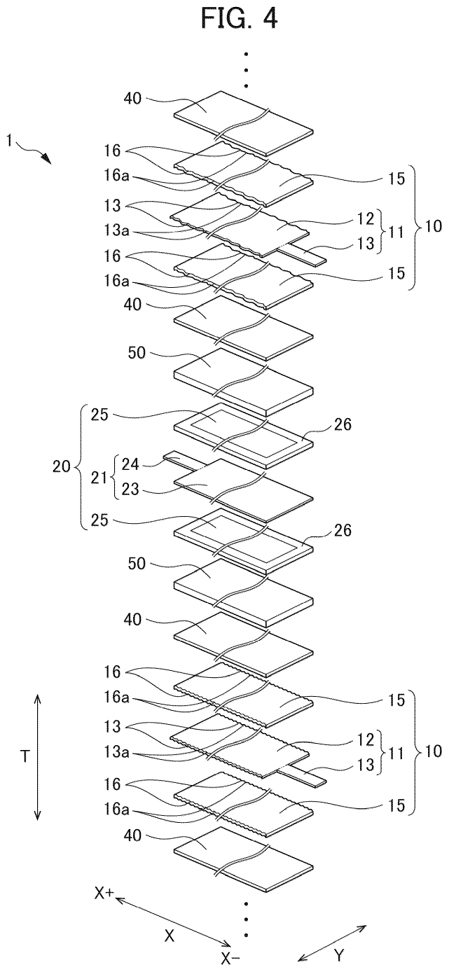

The following describes an all-solid-state battery 1 according to an embodiment of the present invention. For example, the type of the all-solid-state battery 1 is, but is not particularly limited to, an all-solid-state lithium battery using lithium ions as charge transfer media. As depicted in FIGS. 1 to 4, the all-solid-state battery 1 has a structure in which positive electrode layers 20 and negative electrode layers 10 are laminated with solid electrolyte layers 30 therebetween.

The direction in which the positive electrode layers 20 and the negative electrode layers 10 are laminated with the solid electrolyte layers 30 therebetween is referred to as the “T direction” herein. The T direction corresponds to the laminating direction. One direction from among directions orthogonal to the T direction is referred to as the “X direction.”

The X direction corresponds to a first direction. The direction orthogonal to the T direction and the X direction is referred to as the “Y direction.”

The Y direction corresponds to a second direction. One side in the X direction is referred to as the “X+ direction,” and the side opposite from the X+ direction is referred to as the “X-direction.”

### All-Solid-State Battery

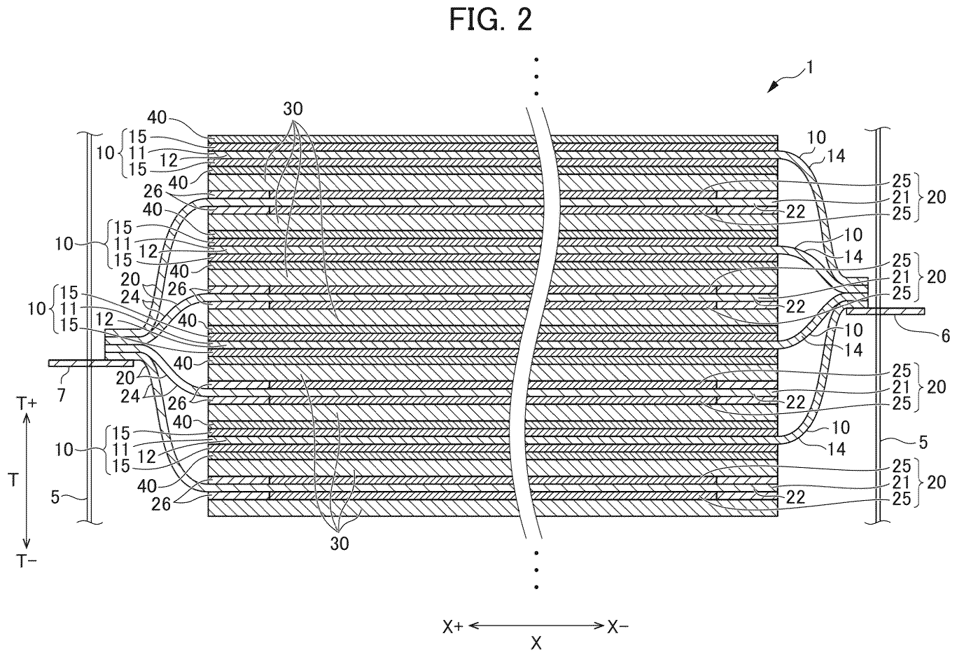

For example, the all-solid-state battery 1 includes a plurality of negative electrode layers 10, a plurality of solid electrolyte layers 30, and a plurality of positive electrode layers 20. A negative electrode layer 10, a solid electrolyte layer 30, a positive electrode layer 20, and a solid electrolyte layer 30 are laminated in this order. The total number of laminated negative electrode layers 10 and positive electrode layers 20 is preferably, but is not particularly limited to, 10 or larger. Note that the vicinities of the end portions of the all-solid-state battery 1 in the T direction are omitted in FIGS. 2-4.

The all-solid-state battery 1 includes an exterior part 5, a negative electrode tab lead 6, and a positive electrode tab lead 7. The exterior part 5 is provided on the surface of the all-solid-state battery 1. The exterior part 5 covers a laminate of negative electrode layers 10, solid electrolyte layers 30, and positive electrode layers 20. For example, the exterior part 5 is formed from a resin. In FIG. 1, the exterior part 5 is indicated by an alternate long and two short dashes line. The negative electrode tab lead 6 is connected to negative electrode tabs 14 (described hereinafter) in a collected state. The negative electrode tab lead 6 is led out from the exterior part 5. The positive electrode tab lead 7 is connected to positive electrode tabs 24 (described hereinafter) in a collected state. The positive electrode tab lead 7 is led out from the exterior part 5.

### Negative Electrode Layer

The negative electrode layers 10 have at least negative-electrode current collector layers 11, in particular, have negative-electrode active material layers 15 and negative-electrode current collector layers 11. For example, one negative electrode layer 10 has one negative-electrode current collector layer 11 and two negative-electrode active material layers 15 provided so as to have the negative-electrode current collector layer 11 interposed therebetween in the T direction.

The negative-electrode active material layer 15 contains a negative-electrode active material. The negative-electrode active material may be, for example, lithium metal, a lithium alloy, silicon (Si), a silicon-based active material such as a silicon alloy, a lithium transition metal oxide such as lithium titanate (Li₄Ti₅O₁₂), a transition metal oxide such as TiO₂, Nb₂O₃, or WO₃, a metal sulfide, a metal nitride, graphite, a carbon material such as soft carbon or hard carbon, or metallic indium. The negative-electrode active material layer 15 is preferably formed from lithium metal. The negative-electrode active material layer 15 may further contain, for example, a solid electrolyte, an electric conduction aid, and a binder.

For example, the negative-electrode active material layer 15 is shaped like a flat plate having a plate surface extending in the X direction and the Y direction. For example, when viewed in the T direction, the negative-electrode active material layer 15 is shaped like a rectangle having a long side extending in the X direction. The thickness (one side) of the negative-electrode active material layer 15 is preferably 0.005 mm to 0.100 mm.

The negative-electrode current collector layer 11 is provided adjacent to negative-electrode active material layers 15. For example, the negative-electrode current collector layer 11 is formed from copper, but the present invention is not particularly limited to this. For example, the negative-electrode current collector layer 11 has a foil shape. The thickness of the negative-electrode current collector layer 11 is preferably 0.006 mm to 0.050 mm. The negative-electrode current collector layer 11 has a negative-electrode current collector layer body part 12 and a negative electrode tab 14.

The negative-electrode current collector layer body part 12 is a portion of the negative-electrode current collector layer 11 that is oriented toward a positive electrode layer 20. The negative-electrode current collector layer body part 12 is a portion overlapping the adjacent negative-electrode active material layers 15 in the T direction. For example, when viewed in the T direction, the negative-electrode current collector layer body part 12 is substantially shaped like a rectangle having a long side extending in the X direction. The negative-electrode active material layers 15 may also not be provided, such that metal (e.g., lithium) is directly deposited on the negative-electrode current collector layer body part 12.

The negative electrode tab 14 is a portion of the negative-electrode current collector layer 11 that extends in a prescribed direction from the negative-electrode current collector layer body part 12. For example, the negative electrode tab 14 extends from the negative-electrode current collector layer body part 12 to one side in the X direction (in particular, X-direction). The Y direction size of the negative electrode tab 14 is smaller than the Y direction size of the negative-electrode current collector layer body part 12. For example, when viewed in the T direction, the negative electrode tab 14 is substantially shaped like a rectangle having a long side extending in the X direction. The leading end portions of a plurality of negative electrode tabs 14 are collected together.

### Solid Electrolyte Layer

A solid electrolyte layer 30 is provided between a negative electrode layer 10 and a positive electrode layer 20. The solid electrolyte layer 30 contains a solid electrolyte material. The solid electrolyte material may be, for example, a sulfide solid electrolyte material or an oxide solid electrolyte material.

### Positive Electrode Layer

The positive electrode layers 20 have positive-electrode active material layers 25 and positive-electrode current collector layers 21. For example, one positive electrode layer 20 has one positive-electrode current collector layer 21 and two positive-electrode active material layers 25 provided so as to have the positive-electrode current collector layer 21 interposed therebetween in the T direction.

The positive-electrode active material layer 25 contains a positive-electrode active material. The positive-electrode active material may be, for example, a transition metal chalcogenide such as titanium disulfide, molybdenum disulfide, or niobium selenide, or a transition metal oxide such as lithium nickelate (LiNiO₂), lithium manganate oxide (LiMnO₂, LiMn₂O₄), or lithium cobalt oxide (LiCoO₂). The positive-electrode active material layer 25 may further contain, for example, a solid electrolyte, an electric conduction aid, and a binding agent.

For example, the positive-electrode active material layer 25 is shaped like a flat plate having a plate surface extending in the X direction and the Y direction. For example, when viewed in the T direction, the positive-electrode active material layer 25 is shaped like a rectangle having a long side extending in the X direction.

For example, an insulating frame 26 is provided to an outer peripheral portion of the positive-electrode active material layer 25.

The insulating frame 26 contains a material having an electron insulating property. The material having an electron insulating property may be, for example, an insulating oxide such as alumina, a resin such as polyvinylidene fluoride (PVDF), or rubber such as styrene-butadiene rubber (SBR). The insulating frame 26 is preferably formed from alumina. The insulating frame 26 may have ion conductivity.

The insulating frame 26 is substantially shaped like a flat plate having a plate surface extending in the X direction and the Y direction. For example, when viewed in the T direction, the insulating frame 26 is substantially shaped like a rectangular frame having a long side extending in the X direction.

The insulating frame 26 can suppress shorting in the all-solid-state battery 1 and improve the strength of the all-solid-state battery 1.

The positive-electrode current collector layer 21 is provided adjacent to positive-electrode active material layers 25. The positive-electrode current collector layer 21 is formed from a current collector. The current collector may be, for example, aluminum, copper, nickel, vanadium, iron, titanium, stainless steel, gold, platinum, or carbon. For example, the positive-electrode current collector layer 21 is formed from aluminum. For example, the positive-electrode current collector layer 21 has a foil shape. The positive-electrode current collector layer 21 has a positive-electrode current collector layer body part 22 and a positive electrode tab 24.

The positive-electrode current collector layer body part 22 is a portion of the positive-electrode current collector layer 21 that overlaps, in the T direction, a positive-electrode active material layer 25 adjacent to the positive-electrode current collector layer 21, in particular, a portion that overlaps, in the T direction, at least either of the two positive-electrode active material layers 25 adjacent to the positive-electrode current collector layer 21. For example, when viewed in the T direction, the positive-electrode current collector layer body part 22 is shaped like a rectangle having a long side extending in the X direction.

In a case where an insulating frame 26 is provided to the positive-electrode active material layer 25, the “portion of the positive-electrode current collector layer 21 that overlaps, in the T direction, a positive-electrode active material layer 25 adjacent to the positive-electrode current collector layer 21” means a portion of the positive-electrode current collector layer 21 that overlaps, in the T direction, at least either a positive-electrode active material layer 25 adjacent to the positive-electrode current collector layer 21 or an insulating frame 26 provided to an outer peripheral portion of the positive-electrode active material layer 25.

The positive electrode tab 24 is a portion of the positive-electrode current collector layer 21 that extends in a prescribed direction from the positive-electrode current collector layer body part 22. For example, the positive electrode tab 24 extends from the positive-electrode current collector layer body part 22 to one side in the X direction (in particular, X+ direction). The Y direction size of the positive electrode tab 24 is smaller than the Y direction size of the positive-electrode current collector layer body part 22. For example, when viewed in the T direction, the positive electrode tab 24 is substantially shaped like a rectangle having a long side extending in the X direction. The leading end portions of a plurality of positive electrode tabs 24 are collected together.

### Intermediate Layer

For example, the all-solid-state battery 1 includes a plurality of intermediate layers 40 each provided between a negative electrode layer 10 and a solid electrolyte layer 30 adjacent to each other.

For example, the intermediate layer 40 contains carbon and a metal that can be alloyed with lithium. The metal that can be alloyed with lithium may be, for example, Mg, Zn, Al, In, Si, Ge, Sn, Ag, Au, Pt, Pd, Pb, Sb, or Bi. For example, the intermediate layer 40 is substantially shaped like a rectangular plate having a plate surface extending in the X direction and the Y direction.

The intermediate layer 40 is formed in such a manner as to be softer than the negative electrode layer 10 and the solid electrolyte layer 30 such that the intermediate layer 40 is in easily close contact with the negative electrode layer 10 and the solid electrolyte layer 30. The intermediate layer 40 can suppress the negative electrode layer 10 and the solid electrolyte layer 30 being stripped from each other.

### Shape of Negative Electrode Layer

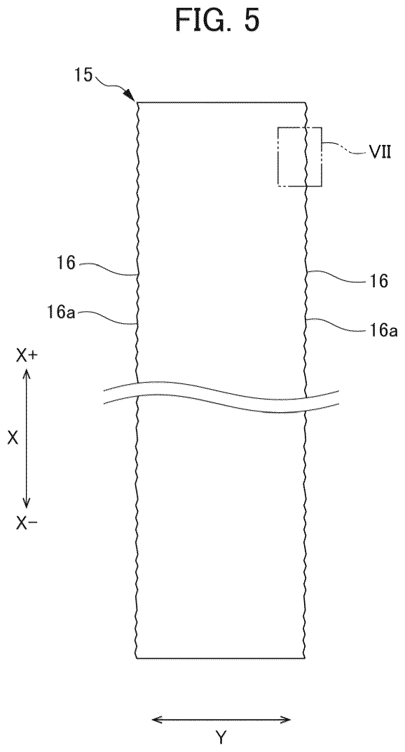

As depicted in FIG. 5, the outer peripheral surface of the negative-electrode active material layer 15 has a pair of side surface sections 16 opposite from each other in the Y direction. The side surface sections 16 each extend in the X direction. When viewed in the T direction, each of the side surface sections 16 has an uneven section 16a.

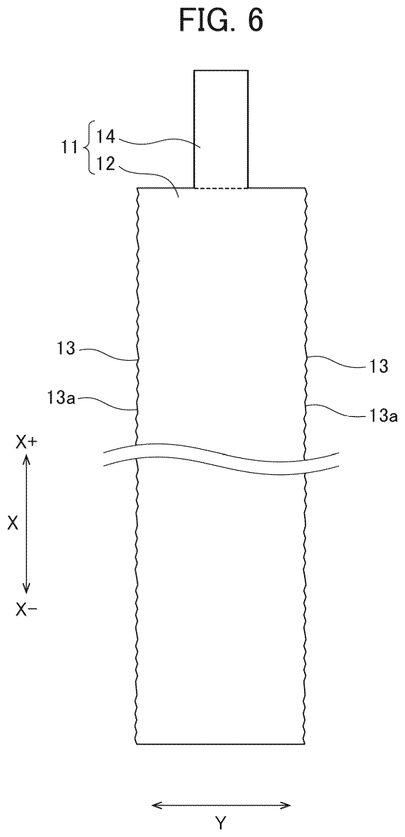

As depicted in FIG. 6, the outer peripheral surface of the negative-electrode current collector layer body part 12 has a pair of side surface sections 13 opposite from each other in the Y direction. The side surface sections 13 each extend in the X direction. When viewed in the T direction, each of the side surface sections 13 has an uneven section 13a that includes recesses and protrusions repetitively arranged in the X direction.

The side surface sections 13 and the side surface sections 16 are collectively referred to as “side surface sections 13, 16.”

The uneven section 13a and the uneven section 16a are collectively referred to as “uneven sections 13a, 16a.” The outer peripheral surface of the negative electrode layer 10 has a pair of side surface sections 13, 16 opposite from each other in the Y direction. When viewed in the T direction, each of the side surface sections 13, 16 has uneven sections 13a, 16a.

For example, the uneven sections 13a of the negative-electrode current collector layer body part 12 have the same shape as the uneven sections 16a of the negative-electrode active material layers 15. Accordingly, an uneven section 16a is described hereinafter on behalf of the uneven sections 13a, 16a.

The uneven section 16a has recesses and protrusions in the Y direction. The uneven section 16a includes a plurality of pairs of recesses and protrusions repetitively arranged in the X direction, and preferably includes 100 or more pairs of recesses and protrusions repetitively arranged. At least either of the side surface sections 16 is provided with an uneven section 16a, in particular, the side surface sections 16 are each provided with an uneven section 16a. The uneven section 16a may be pointed or may be rounded.

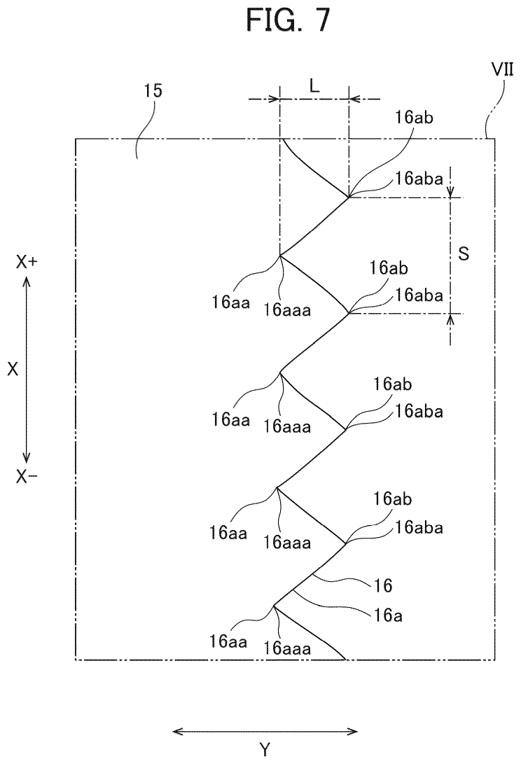

As depicted in FIG. 7, the uneven section 16a has a plurality of recesses 16aa and a plurality of protrusions 16ab. With respect to the recesses 16aa and the protrusions 16ab forming the uneven section 16a, the distance in the Y direction between a bottom 16aaa of one recess 16aa and a top 16aba of a protrusion 16ab adjacent to the recess 16aa is referred to as an “unevenness amount L.”

The unevenness amount L is preferably 0.4 mm or less.

The unevenness amount L is preferably 0.1 mm or greater.

The unevenness amount L is preferably 0.1 mm to 0.4 mm.

With respect to the protrusions 16ab forming the uneven section 16a, the distance in the X direction between the top 16aba of one protrusion 16ab and the top 16aba of a protrusion 16ab adjacent to the one protrusion 16ab is referred to as an “unevenness pitch S.”

The unevenness pitch S is preferably 1.2 mm or less.

The unevenness pitch S is preferably 0.5 mm or greater.

The unevenness pitch S is preferably 0.5 mm to 1.2 mm.

The uneven section 16a can be formed by cutting the negative electrode layer 10 by using a cutter having a corrugated blade in a step for manufacturing the all-solid-state battery 1. For example, the cutter having a corrugated blade is a rotary cutter having a corrugated blade. The unevenness amount L and the unevenness pitch S of the uneven section 16a can be adjusted by adjusting the shape of the corrugated blade. In the meantime, an uneven section 13a and uneven sections 16a can be concurrently formed by, for example, cutting a negative-electrode current collector layer 11 and negative-electrode active material layers 15 laminated atop one another.

### Effects Pertaining to Embodiment

The above embodiment can provide the following effects.

According to the embodiment described above, a negative-electrode current collector layer 11 has a negative-electrode current collector layer body part 12 overlapping a negative-electrode active material layer 15 in the T direction, and a negative electrode tab 14 extending from the negative-electrode current collector layer body part 12 in the X-direction. The outer peripheral surface of the negative electrode layer 10 has a pair of side surface sections 13, 16 opposite from each other in the Y direction. When viewed in the T direction, the side surface sections 13, 16 respectively have uneven sections 13a, 16a.

In such a configuration, the side surface sections 13, 16 of the negative electrode layer 10 can have an increased surface area so that a metal deposited on the negative electrode layer 10 can be easily fixed to the side surface sections 13, 16. In this way, it is possible to suppress the metal deposited on the negative electrode layer 10 from detaching from the negative electrode layer 10, thereby suppressing deterioration of the negative electrode layer 10. Hence, an all-solid-state battery 1 can be provided that is unlikely to exhibit a decrease in the capacity associated with deterioration of the negative electrode layer even when charging/discharging is repeatedly performed, thereby achieving excellent cycle characteristics.

In the embodiment described above, the negative electrode layer 10 has negative-electrode active material layers 15. The outer peripheral surface of each of the negative-electrode active material layers 15 has a pair of side surface sections 16 opposite from each other in the Y direction. When viewed in the T direction, each of the side surface sections 16 has an uneven section 16a.

In a case where the negative electrode layer 10 has negative-electrode active material layers 15, metal is deposited on the side surface sections 16 of the negative-electrode active material layers 15 while the all-solid-state battery 1 is charged. In such a configuration, the metal deposited on the negative-electrode active material layers 15 can be easily fixed to the side surface sections 16 of the negative-electrode active material layers 15. As a result, it is possible to suppress the metal deposited on the negative-electrode active material layers 15 from detaching from the negative-electrode active material layers 15.

In the embodiment described above, the outer peripheral surface of each of the negative-electrode active material layers 15 has a pair of side surface sections 16 opposite from each other in the Y direction. When viewed in the T direction, each of the side surface sections 16 has an uneven section 16a.

In a case where the negative electrode layer 10 has negative-electrode active material layers 15, metal is deposited on the side surface sections 16 of the negative-electrode active material layers 15 while the all-solid-state battery 1 is charged. In such a configuration, the metal deposited on the negative-electrode active material layers 15 can be easily fixed to the side surface sections 16 of the negative-electrode active material layers 15. As a result, it is possible to suppress the metal deposited on the negative-electrode active material layers 15 from detaching from the negative-electrode active material layers 15.

With respect to a plurality of recesses 16aa and a plurality of protrusions 16ab forming the uneven section 16a of a negative-electrode active material layer 15, the distance in the Y direction between the bottom 16aaa of one recess 16aa and the top 16aba of a protrusion 16ab adjacent to the recess 16aa is referred to as an “unevenness amount L.” The unevenness amount L is preferably 0.4 mm or less.

In such a configuration, the Y direction size of the protrusion 16ab being excessively large can be suppressed, thereby suppressing an occurrence of shorting that could be caused by the leading end of a protrusion 16ab contacting the surroundings.

The unevenness amount L is preferably 0.10 mm or greater.

In such a configuration, the uneven section 16a can have a sufficiently increased surface area so that the metal deposited on the uneven section 16a can be sufficiently fixed to the uneven section 16a. As a result, it is possible to suppress the metal deposited on the negative-electrode active material layers 15 from detaching from the negative-electrode active material layers 15.

The unevenness amount L is preferably 0.10 mm to 0.40 mm.

In such a configuration, it is possible to suppress the metal deposited on the negative-electrode active material layer 15 from detaching from the negative-electrode active material layer 15, and suppress an occurrence of shorting that could be caused by a protrusion 16ab contacting the surroundings.

With respect to a plurality of protrusions 16ab forming the uneven sections 16a of a negative-electrode active material layer 15, the distance in the X direction between the top 16aba of one protrusion 16ab and the top 16aba of a protrusion 16ab adjacent to the one protrusion 16ab is referred to as an “unevenness pitch S.” The unevenness pitch S is preferably 1.2 mm or less.

In such a configuration, the surface area of the uneven section 16a can be sufficiently increased by increasing the number of recesses and protrusions forming the uneven section 16a. As a result, the metal deposited on the uneven section 16a can be sufficiently fixed to the uneven section 16a, thereby suppressing the metal deposited on the negative-electrode active material layer 15 from detaching from the negative-electrode active material layer 15.

The unevenness pitch S is preferably 0.50 mm or greater.

In such a configuration, spaces in which metal is to be deposited can be easily ensured between adjacent protrusions so that the metal deposited on the uneven section 16a can be easily fixed to the uneven section 16a. As a result, it is possible to suppress the metal deposited on the negative-electrode active material layer 15 from detaching from the negative-electrode active material layer 15.

The unevenness pitch S is preferably 0.50 mm to 1.20 mm.

If the unevenness pitch S is excessively small, it would be difficult to ensure, between adjacent protrusions, spaces in which metal is to be deposited, so it may be impossible to sufficiently increase the area of portions of the uneven section 16a on which metal can be deposited. Meanwhile, increasing the unevenness pitch S makes the inclined surfaces of the uneven section 16a smoother, thereby causing the uneven section 16a to have a shape close to a straight line. In this case, the surface area of the uneven section 16a may possibly not be sufficiently increased. In contrast, in the above configuration, such defects can be suppressed, thereby suppressing the metal deposited on the negative-electrode active material layer 15 from detaching from the negative-electrode active material layer 15.

In the embodiment described above, the negative electrode layer 10 has a negative-electrode current collector layer 11 and negative-electrode active material layers 15. However, the negative electrode layer does not need to have negative-electrode active material layers, as long as the same has at least a negative-electrode current collector layer. In this case, a metal (lithium) may be deposited on the side surface sections of the negative-electrode current collector layer while the all-solid-state battery is charged. The metal deposited on the negative-electrode current collector layer may possibly detach from the negative-electrode current collector layer in association with expansion or contraction of the all-solid-state battery.

However, similar effects to the embodiment described above can be achieved by forming uneven sections on the side surface sections of negative-electrode current collector layers and by making the configuration of the uneven sections of the negative-electrode current collector layers similar to that of the uneven sections 16a of the negative-electrode active material layers 15 in the embodiment described above.

The present invention is not limited to the configurations in the embodiment described above, and changes can be appropriately made and applied without changing the gist of the present invention. The present invention may also include a combination of two or more desirable configurations described with reference to the embodiment described above.

### Examples

1. Manufacturing of all-Solid-State Battery

### Negative-Electrode Current Collector

As a negative-electrode current collector, copper foil was prepared that includes: a body section having, on side surfaces thereof, uneven sections having an unevenness amount L of 0.05 mm, 0.10 mm, 0.20 mm, 0.40 mm, or 0.50 mm and an unevenness pitch S of 0.30 mm, 0.50 mm, 0.70 mm, 1.20 mm, or 1.50 mm; and a tab section extending from the body section.

### Production of Negative Electrode Layer

As a negative-electrode active material layer, lithium foil (thickness: 40 μm) was prepared that includes, on side surfaces thereof, uneven sections having an unevenness amount L of 0.05 mm, 0.10 mm, 0.20 mm, 0.40 mm, or 0.50 mm and an unevenness pitch S of 0.30 mm, 0.50 mm, 0.70 mm, 1.20 mm, or 1.50 mm. The lithium foil was laminated on each of surfaces of the prepared copper foil so as to produce a negative electrode layer. The unevenness amount L and the unevenness pitch S of the copper foil and the unevenness amount L and the unevenness pitch S of the lithium foil were adjusted by using different corrugated blades.

### Production of Positive Electrode Layer

As a positive-electrode current collector, aluminum foil (thickness: 5.0 μm) was prepared that includes a body section and a tab section extending from the body section. A positive-electrode active material was produced by mixing 80 parts by mass of lithium nickel cobalt manganese composite oxide (NCM 622), 17 parts by mass of argyrodite-based sulfide solid electrolyte as a solid electrolyte, 2 parts by mass of carbon black as an electric conduction aid, and 1 part by mass of styrene-butadiene rubber (SBR) based binder as a binding agent. The obtained mixture was dispersed in 43 parts by mass of butyl butyrate so as to prepare positive-electrode active material layer slurry. The obtained positive-electrode active material layer slurry was applied to one surface of the positive-electrode current collector by using a bar coater such that the weight of coating will be 27 mg/cm² after drying, and the resultant structure was dried so as to form a positive-electrode active material layer having a thickness of 80.0 μm, thereby producing a positive electrode layer.

### Production of Solid Electrolyte Layer Transfer Sheet

A dispersion liquid of argyrodite-based sulfide solid electrolyte (median diameter: 3.0 μm) was applied to a support sheet, and the result was dried so as to form an argyrodite-based sulfide solid electrolyte layer, thereby producing a solid electrolyte layer transfer sheet.

### Production of Intermediate Layer Transfer Sheet

95 parts by mass of combination of Sn particles (median diameter: 0.07 μm), which serve as metal nanoparticles, and acetylene black (median diameter: 0.05 μm), which serves as amorphous carbon, was mixed with 5 parts by mass of a PVDF-based binder, which serves as a binding agent. The obtained mixture was dispersed in 1,000 parts by mass of N-methyl-2-pyrrolidone (NMP) so as to prepare intermediate layer slurry. The obtained intermediate layer slurry was applied to a support sheet and dried so as to produce an intermediate layer transfer sheet in such a manner as to achieve a final thickness of 3.0 μm.

Production of all-Solid-State Battery

The intermediate layer of the intermediate layer transfer sheet was transferred onto the metal lithium foil of the negative electrode layer, and then the negative electrode layer and the intermediate layer were subjected to press-bonding so as to produce an intermediate layer/negative electrode layer laminate. Next, the solid electrolyte layer of the solid electrolyte layer transfer sheet was disposed on the intermediate layer of the intermediate layer/negative electrode layer laminate, and the resultant structure was subjected to press-bonding, and then the support sheet of the solid electrolyte layer transfer sheet was stripped off, thereby producing a solid electrolyte layer/intermediate layer/negative electrode layer laminate. Subsequently, the positive-electrode active material layer of the positive electrode layer was disposed on the solid electrolyte layer of the solid electrolyte layer/intermediate layer/negative electrode layer laminate, and the resultant structure was subjected to press-bonding, thereby producing a positive electrode layer/solid electrolyte layer/intermediate layer/negative electrode layer laminate. The obtained laminate was accommodated in an exterior part, the tab section of the positive electrode layer was connected to the positive electrode tab lead, and the tab section of the negative electrode layer was connected to the negative electrode tab lead, after which the exterior part was sealed, thereby providing an all-solid-state battery.

The portion of the all-solid-state battery that corresponds to the laminate (i.e., portion of the all-solid-state battery excluding the positive electrode tab and the negative electrode tab) had a size of X×Y×T=530 mm×102 mm×0.245 mm. The X direction size of the negative-electrode active material layer 15 was 0.010 mm.

### 2. Evaluation

A charge and discharge test was performed using the obtained all-solid-state battery. The charge and discharge test was repeated four times for the produced battery at 0.1 C rates with a lower limit voltage of 2.5 V and an upper limit voltage of 4.2 V, and the discharge capacity obtained in the fourth test was defined as an initial capacity. Rates were determined on the assumption that the capacity in this situation was 100%. For each of examples and comparative examples, the test was performed using 10 samples of the all-solid-state battery. In the charge and discharge test, charge and discharge were repeated 500 times at 0.5 C rates with a lower limit voltage of 2.5 V and an upper limit voltage of 4.2 V in an environment with a temperature of 55° C.

The all-solid-state battery after the charge and discharge test was checked for the presence/absence of shorting. In each of the examples and comparative examples, the discharge capacity retention rate (%; may simply be referred to as the “capacity retention rate”) after the charge and discharge test was measured. For each of the examples and comparative examples, an evaluation of “shorting present (poor)” was given when the capacity retention rate was lower than 90%, and an evaluation of “shorting not present (good)” was given when the capacity retention rate was 90% or higher. For comparative examples to which an evaluation of “poor” was given, the cause of the occurrence of shorting was checked.

### 3. Measurement Result

Tables 1 to 5 indicate, for each of comparative examples and examples, an unevenness amount L (mm), an unevenness pitch S (mm), the capacity retention rate after the charge and discharge test (%), an evaluation result pertaining to the presence/absence of shorting, and the cause of shorting. Although not indicated in the tables, the capacity retention rate in a comparative example in which the unevenness amount L was 0 mm and the unevenness pitch S was 0 mm was 358, and an evaluation of “poor” was given to this example.

Table 1 indicates the results of comparative examples 1-1 to 1-5 in which the unevenness amount L is 0.05 mm and the unevenness pitch S is 0.30 mm, 0.50 mm, 0.70 mm, 1.20 mm, or 1.50 mm.

TABLE 1

| | Un- | Un- | Capacity | | |
|---|---|---|---|---|---|
| | evenness | evenness | retention | | |
| | amount L | pitch S | rate | | |
| | (mm) | (mm) | (%) | Assessment | Cause of shorting |
| Comparative Example1-1 | 0.05 | 0.30 | 50 | Poor | Shorting caused by detachment from negative electrode layer |
| Comparative Example1-2 | | 0.50 | 48 | Poor | Shorting caused by detachment from negative electrode layer |
| Comparative Example1-3 | | 0.70 | 48 | Poor | Shorting caused by detachment from negative electrode layer |
| Comparative Example1-4 | | 1.20 | 52 | Poor | Shorting caused by detachment from negative electrode layer |
| Comparative Example1-5 | | 1.50 | 56 | Poor | Shorting caused by detachment from negative electrode layer |

Table 2 indicates the results of comparative examples 2-1 to 2-5 in which the unevenness amount L is 0.10 mm and the unevenness pitch S is 0.30 mm, 0.50 mm, 0.70 mm, 1.20 mm, or 1.50 mm.

TABLE 2

| | Un- | Un- | Capacity | | |
|---|---|---|---|---|---|
| | evenness | evenness | retention | | |
| | amount L | pitch S | rate | | |
| | (mm) | (mm) | (%) | Assessment | Cause of shorting |
| Comparative Example2-1 | 0.10 | 0.30 | 46 | Poor | Shorting caused by detachment from negative electrode layer |
| Example2-1 | | 0.50 | 95 | Good | — |
| Example2-2 | | 0.70 | 97 | Good | — |
| Example2-3 | | 1.20 | 95 | Good | — |
| Comparative Example2-2 | | 1.50 | 55 | Poor | Shorting caused by detachment from negative electrode layer |

Table 3 indicates the results of comparative examples 3-1 and 3-2 and examples 3-1 to 3-3 in which the unevenness amount L is 0.20 mm and the unevenness pitch S is 0.30 mm, 0.50 mm, 0.70 mm, 1.20 mm, or 1.50 mm.

TABLE 3

| | Un- | Un- | Capacity | | |
|---|---|---|---|---|---|
| | evenness | evenness | retention | | |
| | amount L | pitch S | rate | | |
| | (mm) | (mm) | (%) | Assessment | Cause of shorting |
| Comparative Example3-1 | 0.20 | 0.30 | 44 | Poor | Shorting caused by protrusion |
| Example3-1 | | 0.50 | 95 | Good | — |
| Example3-2 | | 0.70 | 98 | Good | — |
| Example3-3 | | 1.20 | 96 | Good | — |
| Comparative Example3-2 | | 1.50 | 53 | Poor | Shorting caused by detachment from negative electrode layer |

Table 4 indicates the results of comparative examples 4-1 and 4-2 and examples 4-1 to 4-3 in which the unevenness amount L is 0.40 mm and the unevenness pitch S is 0.30 mm, 0.50 mm, 0.70 mm, 1.20 mm, or 1.50 mm.

TABLE 4

| | Un- | Un- | Capacity | | |
|---|---|---|---|---|---|
| | evenness | evenness | retention | | |
| | amount L | pitch S | rate | | |
| | (mm) | (mm) | (%) | Assessment | Cause of shorting |
| Comparative Example4-1 | 0.40 | 0.30 | 42 | Poor | Shorting caused by protrusion |
| Example4-1 | | 0.50 | 92 | Good | — |
| Example4-2 | | 0.70 | 97 | Good | — |
| Example4-3 | | 1.20 | 95 | Good | — |
| Comparative Example4-2 | | 1.50 | 50 | Poor | Shorting caused by protrusion |

Table 5 indicates the results of comparative examples 5-1 to 5-5 in which the unevenness amount L is 0.50 mm and the unevenness pitch S is 0.30 mm, 0.50 mm, 0.70 mm, 1.20 mm, or 1.50 mm.

TABLE 5

| | Un- | Un- | Capacity | | |
|---|---|---|---|---|---|
| | evenness | evenness | retention | | |
| | amount L | pitch S | rate | | |
| | (mm) | (mm) | (%) | Assessment | Cause of shorting |
| Comparative Example5-1 | 0.50 | 0.30 | 39 | Poor | Shorting caused by protrusion |
| Comparative Example5-2 | | 0.50 | 40 | Poor | Shorting caused by protrusion |
| Comparative Example5-3 | | 0.70 | 42 | Poor | Shorting caused by protrusion |
| Comparative Example5-4 | | 1.20 | 45 | Poor | Shorting caused by protrusion |
| Comparative Example5-5 | | 1.50 | 47 | Poor | Shorting caused by protrusion |

First, unevenness amount L is examined.

According to examples 2-1 to 2-3, 3-1 to 3-3, and 4-1 to 4-3, the results were good when the unevenness amount L was 0.20 mm to 0.40 mm. This suggested that the unevenness amount L of 0.20 mm to 0.40 mm can impart sufficient cycle characteristics to the all-solid-state battery.

According to comparative examples 1-1 to 1-5, shorting occurred for all the unevenness pitches S when the unevenness amount L was 0.05 mm. In comparative examples 1-1 to 1-5, detachment from the negative electrode layer was observed. In a case where the unevenness amount L is excessively small, the uneven section has a relatively linear shape, so the surface area of the uneven section is insufficiently large. Thus, it is considered that detachment of metal from the negative-electrode active material layer could not be sufficiently suppressed.

According to the examples and comparative examples 3-1, 3-2, 4-1, 4-2, and 5-1 to 5-5, detachment from the negative electrode layer was not necessarily seen when the unevenness amount L was 0.10 mm or greater. This suggested that the unevenness amount L of 0.10 mm or greater can suppress the detachment from the negative electrode.

According to comparative examples 5-1 to 5-5, shorting occurred for all the unevenness pitches S when the unevenness amount L was 0.5 mm. In comparative examples 1-1 to 1-5, the leading end of a protrusion of a side surface section of the negative electrode layer was in contact with a component in the vicinity of the negative electrode layer. In a case where the unevenness amount L is excessively large, the Y direction size of protrusions is relatively large, so the leading end of a protrusion is easily in contact with a component in the vicinity of the protrusion. Thus, it is considered that shorting easily occurs.

According to the examples and comparative examples 1-1 to 1-5, 2-1, and 3-2, an occurrence of shorting caused by the negative electrode layer (protrusion) contacting the surroundings was not necessarily seen when the unevenness amount L was 0.40 mm or less. This suggested that the unevenness amount L of 0.40 mm or less can suppress an occurrence of shorting caused by the negative electrode layer contacting the surroundings.

Next, unevenness pitch S is examined.

According to examples 1-1, 2-1, 3-1, 4-1, and 5-1, the results were good when the unevenness pitch S was 0.50 mm to 1.20 mm. This suggested that the unevenness pitch S of 0.50 mm to 1.2 mm can impart sufficient cycle characteristics to the all-solid-state battery.

According to comparative examples 1-1, 2-1, 3-1, 4-1, and 5-1, shorting occurred for all the unevenness amounts L when the unevenness pitch S was 0.30 mm. When the unevenness amount L was relatively small (comparative examples 1-1, 2-1), shorting caused by the detachment from the negative electrode layer occurred. In a case where the unevenness pitch S is excessively small, it is difficult to ensure, between adjacent protrusions, spaces in which metal is to be deposited. Thus, it is considered that the area of portions of the uneven section on which metal can be deposited could not be sufficiently increased. When the unevenness amount L was relatively large (comparative examples 3-1, 4-1, 5-1), shorting caused by a protrusion contacting the surroundings occurred. In a case where the unevenness pitch S is excessively large, the side surface sections have relatively many protrusions that are relatively large in the Y direction size, and thus it is considered that shorting occurs due to any of the protrusions contacting the surroundings. When the unevenness amount L was relatively large (comparative examples 3-1, 4-1, 5-1), an occurrence of shorting caused by the detachment from the negative electrode layer was suppressed.

According to comparative examples 1-5, 2-5, 3-5, 4-5, and 5-5, shorting occurred for all the unevenness amounts L when the unevenness pitch S was 1.50 mm. When the unevenness amount L was relatively small (comparative examples 1-5, 2-5, 3-5), shorting caused by the detachment from the negative electrode layer occurred. In a case where the unevenness pitch S is excessively large, the inclined surfaces of the uneven sections are smooth, thereby making the uneven sections relatively linear. It is considered that, in this case, the surface area of the uneven sections could not be sufficiently increased. When the unevenness amount L was relatively large (comparative examples 3-1, 4-1, 5-1), shorting caused by a protrusion contacting the surroundings occurred. When the unevenness amount L was relatively large (comparative examples 3-1, 4-1, 5-1), an occurrence of shorting caused by the detachment from the negative electrode layer was suppressed.

What is claimed is:

1. An all-solid-state battery, comprising: a positive electrode layer and a negative electrode layer laminated together with a solid electrolyte layer interposed therebetween, the negative electrode layer having at least a negative-electrode current collector layer, wherein
direction of lamination is defined as a laminating direction, one direction from among directions orthogonal to the laminating direction is defined as a first direction, and a direction orthogonal to the laminating direction and the first direction is defined as a second direction,
the negative-electrode current collector layer has a negative electrode tab extending to one side in the first direction,
an outer peripheral surface of the negative electrode layer has a pair of side surface sections opposite from each other in the second direction, and
the side surface sections each have an uneven section when viewed in the laminating direction.

2. The all-solid-state battery according to claim 1, wherein
with respect to protrusions and recesses forming the uneven section, a distance in the second direction between a bottom of one recess and a top of a protrusion adjacent to the one recess is defined as an unevenness amount, and
the unevenness amount is 0.10 mm to 0.40 mm.

3. The all-solid-state battery according to claim 1, wherein
with respect to protrusions and recesses forming the uneven section, a distance in the second direction between a bottom of one recess and a top of a protrusion adjacent to the one recess is defined as an unevenness amount, and
the unevenness amount is 0.40 mm or less.

4. The all-solid-state battery according to claim 1, wherein
with respect to protrusions and recesses forming the uneven section, a distance in the second direction between a bottom of one recess and a top of a protrusion adjacent to the one recess is defined as an unevenness amount, and
the unevenness amount is 0.10 mm or greater.

5. The all-solid-state battery according to claim 1, wherein
with respect to protrusions forming the uneven section, a distance in the first direction between a top of one protrusion and a top of a protrusion adjacent to the one protrusion is defined as an unevenness pitch, and
the unevenness pitch is 0.50 mm to 1.20 mm.

6. The all-solid-state battery according to claim 1, wherein
with respect to protrusions forming the uneven section, a distance in the first direction between a top of one protrusion and a top of a protrusion adjacent to the one protrusion is defined as an unevenness pitch, and
the unevenness pitch is 0.50 mm or greater.

7. The all-solid-state battery according to claim 1, wherein
with respect to protrusions forming the uneven section, a distance in the first direction between a top of one protrusion and a top of a protrusion adjacent to the one protrusion is defined as an unevenness pitch, and
the unevenness pitch is 1.20 mm or less.
